(19) United States
(12) Patent Application Publication
(10) Pub. No.: US 2014/0283876 A1
(43) Pub. Date: Sep. 25, 2014

(54) CLEANING PIG

(71) Applicant: FRAS TECHNOLOGY AS, Øvre Ardai (NO)

(72) Inventor: Sølve Fjerdingstad, Kolbotn (NO)

(21) Appl. No.: 14/361,985

(22) PCT Filed: Nov. 30, 2012
(86) PCT No.: PCT/EP2012/074154

§ 371 Date: May 30, 2014

(30) Foreign Application Priority Data
Nov. 30, 2011 (NO) 2011-1655

(51) Int. Cl. B08B 9/055

(52) U.S. Cl. CPC B08B 9/0551
USPC 134/8; 15/3.5

(57) ABSTRACT

A pig (10) for cleaning of a pipeline (1), the pig (10) comprising: a body (11) for passing through the pipeline (1), wherein the body (11) comprises a soft and preferably elastic material and has an outer surface (12) for cleaning an inner surface (2) of the pipeline (1); and a vibration unit (20) within the body (11) for generating vibrations and for transmitting the vibrations to the outer surface (12) of the body (11), wherein the vibration unit (20) is enclosed by the outer surface (12).

The present invention relates to a cleaning pig for cleaning a pipeline.

The use of a pig for cleaning, also known as a cleaning pig, of a pipeline has been known for decades. Thanks to an outer rubbing surface of the pig an inner surface of the pipeline is rubbed as the pig moves though the pipeline. With a hydraulic pig the pig is moved through the pipeline by a fluid circulating in the pipeline.

U.S. Pat. No. 4,077,079 discloses an elastomeric pig having a foamed plastic body with an outer surface that is covered with an abrasive. U.S. Pat. No. 5,442,826 discloses cleaning a pipeline with a pig whilst using an oscillatory circulation of air within the pipeline to generate a to-and-fro cleaning cycle by the pig. The pig may also be put in rotation thanks to a spiral slit groove. However, such solution has been designed in the case of a compressible fluid as a motive fluid, and involves many complex parts, such as conduits, valves, connections and so on to be connected to the pipeline whilst the pig is within the pipeline. A disadvantage of this solution is that is may be expensive, for example in terms of maintenance and/or purchase.

Improved cleaning of pipelines may imply better flow characteristics in the pipeline as well as less contamination of a fluid passed in the pipeline.

Viewed from a first aspect, the present invention provides a pig for cleaning of a pipeline, the pig comprising: a body for passing through the pipeline, wherein the body comprises a soft and preferably elastic material and has an outer surface for cleaning an inner surface of the pipeline; and a vibration unit within the body for generating vibrations and for transmitting the vibrations to the outer surface of the body, wherein the vibration unit is enclosed by the outer surface.

Thanks to the vibration unit, it is possible to vibrate the pig when the pig is passed through a pipeline. The vibrations are transmitted from the vibration unit through the soft polymer material of the body of the pig. As a result of the vibration, cleaning of the inner surface of the pipeline is improved. The soft polymer material moves in oscillation with the vibrations and hence generates additional movement of the outer surface of the pig against the inner surface of the pipeline. In some examples, a frequency of vibration is adjusted in dependence of properties of the inner surface of the pipeline. As a non-limiting example, the frequency of vibration may be modified, e.g. increased, when improved cleaning is desired when it is detected that the inner surface is for example particularly dirty, sensitive to rough cleaning or the like.

The soft polymer material may consist of a deformable and/or resilient material, for example an elastically deformable material. The material should be selected so that when the pig is held within a pipeline the movement of the vibration unit will be able to readily deform the body of the pig by vibrations. Thus, the material should have a suitably low Young's modulus and/or a suitable low strength, which may be a strength measured as a tensile strength or a tear strength. In preferred embodiments the Young's modulus may be 300 MPa or less, preferably 100 MPa or less and more preferably 30 MPa or less. The tensile strength or tear strength may be 100 MPa or less, preferably 30 MPa or less, more preferably 10 MPa or less and yet more preferably 3 MPa or less.

Suitable materials include elastomers such as polyurethanes, butyls, and silicones. Rubber materials (natural and synthetic) and other elastomers with suitable softness may also be used. Another possible material is cork. In some preferred embodiments a foam material is used, for example a polyurethane foam. In one particularly preferred embodiment the soft polymer is a flexible polyether MDI (methylene diphenyl diisocyanate) polyurethane foam, such as a foam of the type designed for moulded components. In the case of a foam material it should be noted that the Young's modulus and other parameters referenced above should be applied to the material when in its final foamed form, rather than to the base material in a solid form. The properties of the particular polymer that forms the base for a foam will of course differ considerable from the properties of the foam material. For foam materials the preferred tensile strength may be even lower than the values given above and may be 1 MPa or less and more preferably 100 kPa or less.

The body of the pig may be made slightly larger than the pipeline that it is intended to clear with deformation of the polymer material then permitting the pig to fit tightly within the pipeline with the outer surface of the pig in close contact with the inner surface of the pipeline.

The soft polymer material should be at outer portions of the body to thereby apply an oscillatory effect to the pipeline inner surface in response to vibrations generated by the vibration unit. The body of the pig may be made entirely of the soft polymer material, aside from perhaps the addition of an outer covering at the outer surface or other additional parts as discussed below. Alternatively the body of the pig may comprise a rigid inner part housing the vibration unit and an outer part made of the soft polymer material. In this case the rigid part may transmit vibrations from the vibration unit to the softer outer part. The rigid inner part should hence preferably be stiffly and preferably rigidly coupled to the vibration unit and to the outer part.

The vibration unit is preferably configured to vibrate the pig in a lateral direction with respect to a direction of travel when the pig is conveyed through the pipeline, i.e. in a radial direction of the pipe. If the pig has become stuck in the pipeline, vibration in the lateral direction and/or deformation of the soft polymer body of the pig due to the vibration may allow the pig to more easily release from its stuck position and continue to pass through the pipeline. As an example, the vibration unit may be an element generating vibrations.

It is preferred for the pig of the first aspect that the pig is a hydraulic pig where the movement of the pig along the pipe driven by action of the fluid within the pipeline, which is hence denoted the motive fluid. Thus in preferred embodiments the pig has no internal mechanism for generating movement along the pipeline by mechanical contact with the pipeline inner surface. The pig hence may not be equipped with driving wheels or the like and preferably is not capable of propulsion by means of the vibration movement. The pig may however include a cable for winched movement along the pipeline. This cable may, in preferred embodiments, also include an electrical connection to provide electrical power for the vibration unit.

The body of the pig may be an elongate body, such as in the shape of a bullet (ogive), egg or the like. In this manner, it may be assured that rotation of the pig only along a longitudinal axis of the pig is allowed. In case of a spherical pig, rotation only along the longitudinal axis may be assured by connecting a set of pigs to form a chain of pigs. In case of spherical pigs, the set comprises at least two pigs. In the general case, in which the body of the pig may be in any shape substantially allowing rotation along the longitudinal axis only, a set of pig may comprise one or more pigs.

There are several ways of mounting the vibration unit to, or into, the pig. The body may comprise an opening for receiving the vibration unit. The body may comprise a first and a second portion, which are detachable from each other for insertion of the vibration unit between the first and second portion. For cases where the body comprises a relatively rigid material (within an outer volume of soft material), it may be preferred that at least one of the first and second portions comprises a cavity for receiving the vibration unit. For cases where the body comprises a relatively soft material at inner portions as well as outer portions, an inner portion of the body may be adaptable for receiving the vibration unit. Here, no cavity in the body is required; instead the soft material is pushed away by the vibration unit when inserted into the pig. In examples, where the vibration unit is easily accessible and detachable from the pig, replacement and maintenance of the vibration unit is facilitated.

It is preferred for the body to be formed with a continuous volume of the soft polymer material, which may be either the majority of the body or may be a volume encasing an inner rigid part. This volume may be solid, for example in the case of a silicone rubber material, or it may have pores, as with a foam material. However in alternative arrangements the body may comprise a discontinuous volume, for example an outer part comprising discs of the soft polymer material about a solid inner part, which may be made of a rigid material or a soft polymer material.

The pipeline may be adapted to convey a fluid, such a oil, water, gases etc. In some examples, the fluid may be a slurry. The slurry may comprise, for example, water and coal particles,

In some preferred embodiments, the vibration unit comprises an electric motor for driving the vibration unit for generation of the vibrations. The pig may further comprise a battery, such a rechargeable battery or a non-rechargeable battery, for powering the electric motor. As an example, the electric motor may be a linear electric motor. The vibration unit may comprise a mechanical generator adapted to receive a fluid for mechanically generating the vibrations. The mechanical generator may be used a complement to the electric motor or as an alternative.

The pig may comprise a generator for generating power to the electric motor. The generator may be configured to be driven by the fluid. The pig may further be connectable to an external power source by means of a cable for providing power to the pig. The external power source may be capable of powering the electric motor or any other electric device comprised in the pig. Examples of such other electric device include, but are not limited to, sensor devices such as cameras, ultra-sound sensors, position detection units and more. It shall be here noted that the expression “connectable by means of a cable” includes, but is not limited to, a pig having a fixedly mounted cable as well as a pig being provided with a connector for connecting the cable.

In preferred embodiments, the pig further comprises a layer enclosing the outer surface. The layer comprises one or more of the following elements for cleaning the inner surface: brushes, appendages such as staples or scraping blades, outlets for jets of a fluid (preferably the motive fluid), and/or an abrasive surface.

The layer may comprise magnetised metal plates to enhance collection of magnetic particles. Such plates may be provided as an alternative to the elements mentioned above or in combination with one or more such element(s). The metal plates may be made of steel, iron or the like. By including the layer enclosing one or more of the elements above, cleaning of the inner surface of the pipeline is improved. In some examples, a linear motor magnetizes the iron elements. In other examples, the iron elements may be magnetized permanently. These elements may be directional, i.e. be designed to have a much better effect in one direction than the opposite one, or they may be symmetrical with regard to the direction of movement when cleaning, e.g. direction of pigging.

In some preferred embodiments, the pig may further comprise at least one protrusion extending, from the vibration unit, in a lateral direction with respect to the body. Said at least one of said at least one protrusion may be configured to provide one or more of the following functions: to transmit the vibrations to the body and the outer surface thereof, to anchor the vibration unit to a position within the body, and/or to dissipate heat from the electric motor.

In some examples, the pig comprises dedicated protrusions for each of the functions listed above, or for any combination of two or more of the functions listed above. For example, it may be advantageous to provide a protrusion that is configured to both anchor the vibration unit to a position and to transmit the vibration to the body and the outer surface since a rigid anchoring may also provide improved transmission of vibrations.

In preferred embodiments of the pig for cleaning, the body comprises at least one channel configured to dissipate heat from the vibration unit and/or electric motor by means of a fluid capable of flowing through said at least one channel. The channel may be a channel open at the ends thereof to the fluid within the pipeline, whereby the fluid within the pipeline is able to flow through the channel and remove heat from the vibration unit and/or electric motor.

In some preferred embodiments, the pig for cleaning is provided with a peripherally arranged spiral groove. Thanks to the groove, the pig may rotate along a longitudinal axis of the pipeline when passed through the pipeline by means of the fluid. The fluid may be received by one or more such spiral grooves.

According to a second aspect, the invention provides a method for adjusting a set of operation parameters relating to a pig for cleaning of a pipeline in which the pig is conveyed. An indication relating to the cleaning of the pipeline is obtained. Next, the set of operation parameters is adjusted based on the indication relating to the cleaning of the pipeline. The features of this aspect may optionally and preferably be combined with the features of the first aspect set out above.

The set of operation parameters relating to the pig may comprise one or more of the following items: a vibration frequency for a vibration unit comprised in the pig, a vibration amplitude for a vibration unit comprised in the pig, a vibration energy level for a vibration unit comprised in the pig, a number of cleanings to be performed between a start point and an end point of the pipeline. As an example, the number of cleaning may be a number of cleaning rounds/passes, or cleaning session. It is to be understood that these items may be combined. The start and end points may define a length of the pipeline for cleaning. The length may encompass the entire pipeline or a portion thereof.

The adjustment of the set of operation parameters may be performed in many different manners.

For example, the adjustment of the set of operation parameters may comprise manually controlling the set of operation parameters.

The adjustment of the set of operation parameters may comprise automatically controlling the set of operation parameters. The pig may comprise a control unit for performing the automatic control of the set of operation parameters.

The adjustment of the set of operation parameters may comprise semi-manually controlling the set of parameters upon recommendations from a control unit. An operator of the system may confirm a set of operation parameters provided by the control unit. As an example, the operator may confirm that a further cleaning round/pass, should be performed.

In further examples, the adjustment may be performed by combining one or more of the above mentioned examples.

In these examples, the controlling of the set of operation parameters may include a control loop which may be dependent on the indication relating to the cleaning of the pipeline. As a non-limiting example, it may here be mentioned that the indication may indicate quality of the fluid and/or the property of the pipeline. The fluid may be analyzed as described briefly below. Additionally or alternatively, the controlling of the pig may be realized by a control unit at the exterior of the pig. Such control unit may communicate, wirelessly and/or by wire, with the pig control unit. The control of the set of operation parameters may in other examples be possible by a sole embarked control unit inside the pig, a sole system control unit external to the pig, or by interaction between the two control units, one control unit within the pig and one control unit being external to the pig.

The indication relating to the cleaning of the pipeline may be obtained by detecting a position of the pig. Then, the indication may be based on the position of the pig. The position of the pig may be measured along the length of the pipeline or obtained as a geographical position coordinate received from a positioning unit, such as a Global Position System (GPS) or the like.

The indication relating to the cleaning of the pipeline may be obtained by measuring, or detecting, a property of the pipeline by means of a sensor device comprised in the pig. Thereafter, the indication is based on the measured property. Expressed differently, the indication is determined based on the measured property. The property of the pipeline may be that there is a welding at some position. The welding may need additional cleaning or scrubbing. Other specific points, or positions, may be connections to the pipe, valves, bends etc.

The indication relating to the cleaning of the pipeline may be obtained by analyzing a fluid flowing in the pipeline. A result from the analysis may form a ground on which the indication may be determined. For example, when the fluid is very dirty, it may be desired to set the indication to indicate required further cleaning. Possibly, the further cleaning may be performed at a different, such as higher, frequency than frequency formerly used during analysis of the fluid. As an alternative, further cleaning may be provided thanks to another cleaning pass.

In some preferred embodiments, the indication is reactively determined. That is to say, the indication is based on a detection, or a measurement, of a property. In response to said detection, or measurement, the indication is set such as to increase or decrease the cleaning effect.

In some preferred embodiments, the indication is predicted, i.e. for a certain position the property of the pipeline may be known from for example a data base comprising information for mapping a position to an indication, optionally via the known property. Furthermore, the indication may be determined based on a previous cleaning, reporting points along the inner surface of the pipeline where strong cleaning was required (for example due to scaling). Such specific “dirty points/positions” may be programmed, and be allocated a special set of operation parameters.

In some preferred embodiments, the pig of the first aspect further comprises a cable for providing power to the pig in order to power the vibration unit. It is preferred that the pig is hydraulic and hence in preferred embodiments this cable does not provide power for motion purposes. Then, when used with the method of the second aspect the pig may be allowed to clean a portion of the pipeline when passing, from a first position to a second position, through the portion of the pipeline. When the pig passes from a first position to a second position, it may be referred to as a cleaning pass. Next, the pig may return from the second position to the first position, e.g. by pulling the cable. In such case, the cable will need to be strong, such as a wire line used for logging in boreholes.

The pulling by means of the cable may comprise rewinding the cable, thereby moving the pig from the second position to the first position. In this manner, a speed of the pig may be adjusted.

A wire line will be able to retain the pig, and thus allow controlling the translation speed on its way to the other end of the pipeline section. On its way back, and provided the motive fluid be pumped at slight under pressure not managing by itself to translate the pig, the extra pull by the cable may also allow a relatively controlled translation speed.

According to a third aspect, the invention provides a system for cleaning of a pipeline. The system comprises a pig, a pipeline with at least one sampling port for receiving a fluid to be passed through the pipeline, and an analyzing unit arranged to receive the fluid via the at least one sampling port of the pipeline. The features of this aspect may optionally and preferably be combined with the features of the first aspect set out above and hence the pig may be as described above.

The analyzing unit may receive the fluid, optionally selectively, from at least one analyzing port of the pipeline. In some examples, it is preferred that the fluid is received from one port at the time such as not to mix fluid from different analyzing ports. In other examples, it may be that the fluid is received from two or more analyzing ports of the pipeline.

The system may further comprise an external control unit, being located outside the pipeline, for controlling a set of operation parameters of the pig. This external control unit may be referred to as a system control unit.

Whilst a pig comprising a soft polymer material is preferred in the aspects set forth above it is also considered that a combination of a rigid polymer body with a vibration unit will provide advantageous results. Hence, viewed from a further aspect the invention provides a pig for cleaning of a pipeline, the pig comprising: a body adapted for passing through the pipeline wherein the body comprises a rigid polymer material and has an outer surface for cleaning an inner surface of the pipeline; and a vibration unit within the body for generating vibrations and for transmitting the vibrations to the outer surface of the body, wherein the vibration unit is encompassed enclosed by the outer surface.

Although this arrangement will not benefit from the additional oscillatory motion generated by transmission of vibrations by the soft polymer of the first aspect, the use of a rigid body is considered to provide an alternative advantage, since the rigid body can be made slightly smaller than the pipeline and will hence vibrate whilst the (rigid) outer surface of the pig come into repeated impact against the inner surface of the pipeline. This produces an aggressive cleaning effect suited for removal of hard deposits from the pipeline and for dislodging dirt from pits or cavities within the inner surface of the pipeline.

The rigid pig of this further aspect may comprise additional features similar to those set out above for the first aspect, for example it may be provided with elements for cleaning the inner surface such as brushes, appendages such as staples or scraping blades, outlets for jets of a fluid, and/or an abrasive surface.

Preferred embodiments of the present invention will now be described by way of example only and with reference to the accompanying drawings, in which:

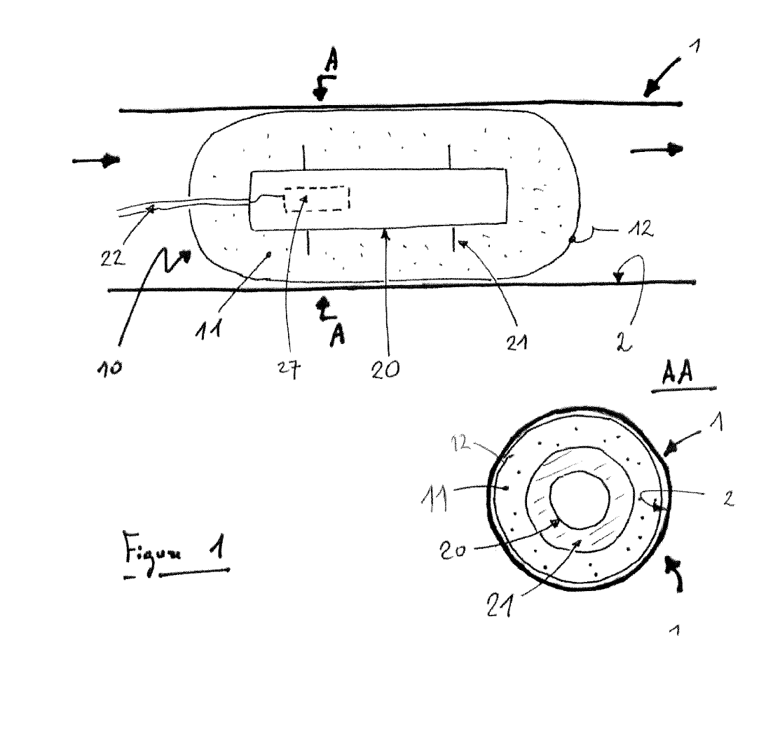

FIG. 1 shows an example of a cleaning pig with a vibration unit and including a power cable;

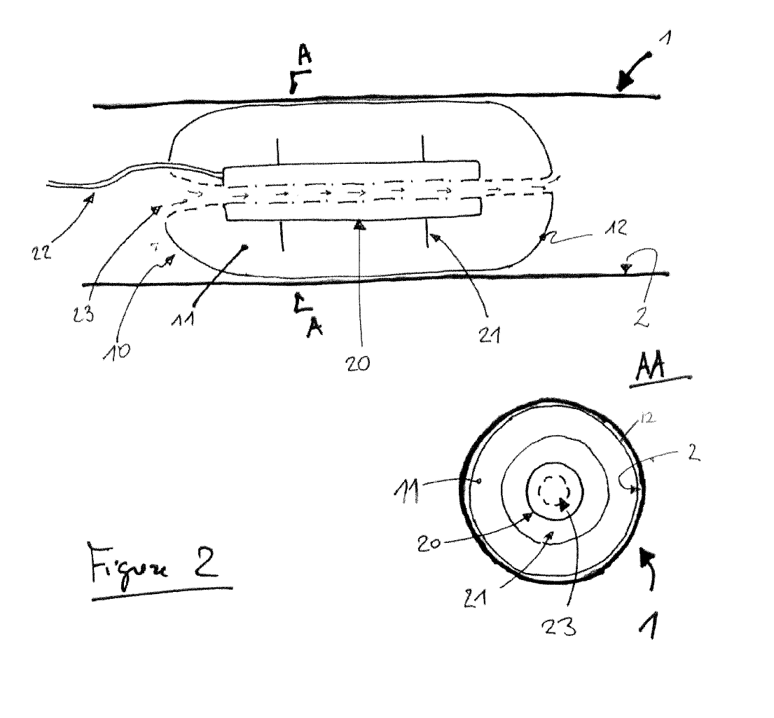

FIG. 2 illustrates an alternative arrangement that also includes a channel for passage of fluid for cooling;

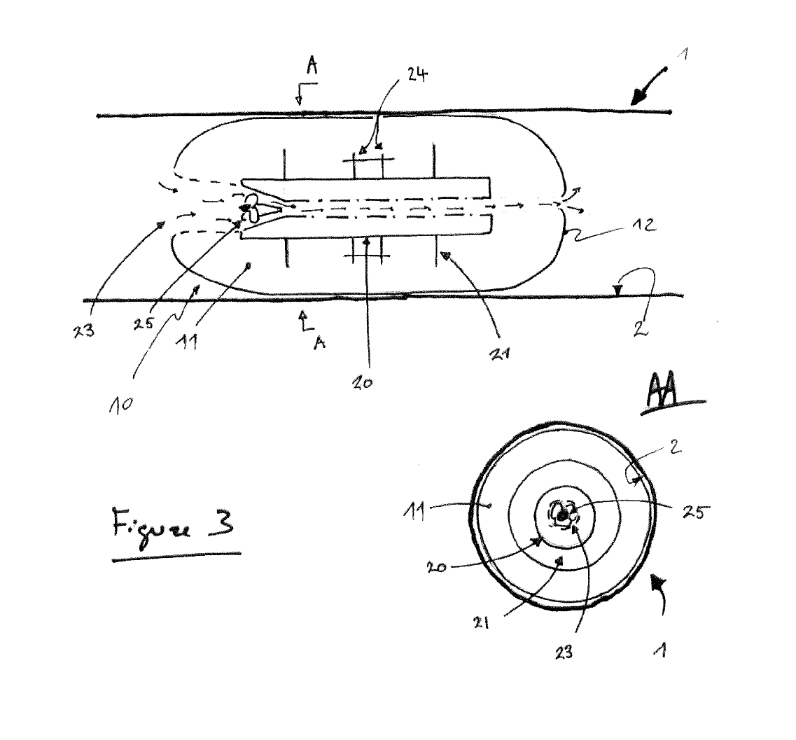

FIG. 3 shows an example of a cleaning pig that has a fluid-driven power generator positioned in a channel, which may serve as a cooling channel;

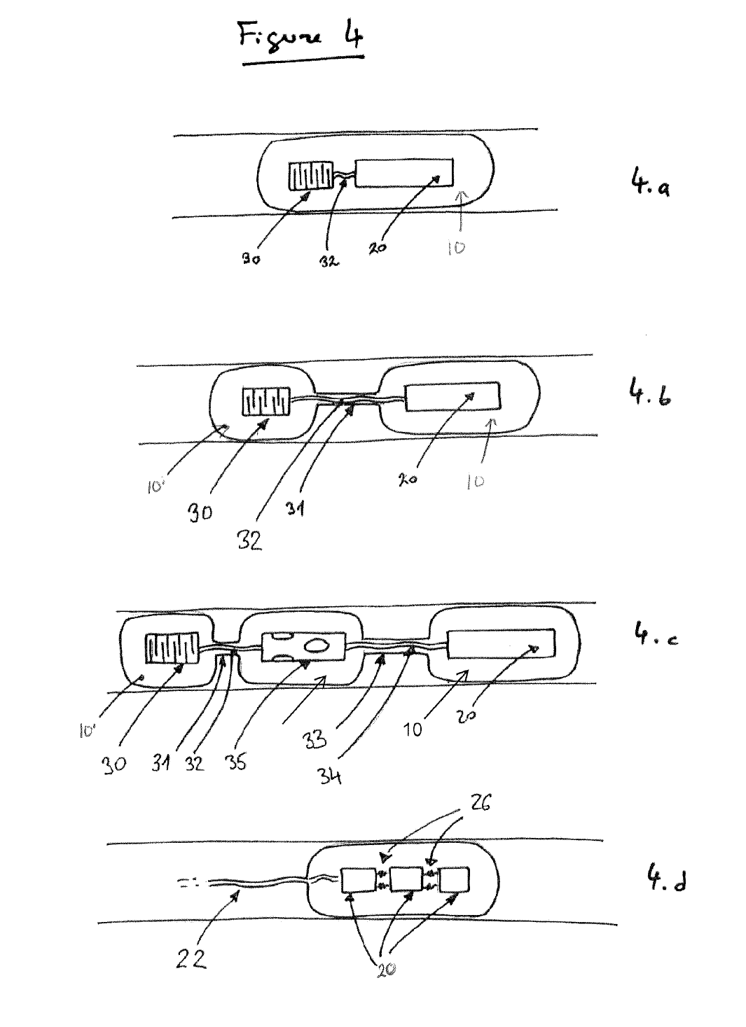

FIG. 4 shows various alternative examples of cleaning pigs, where FIG. 4a shows an autonomous single unit cleaning pig with an embarked battery positioned in the pig, FIG. 4b shows an autonomous double unit cleaning pig with an embarked battery positioned in an additional dedicated pig, FIG. 4c shows an autonomous multi-unit cleaning pig with an embarked battery positioned in an additional dedicated pig, and a sensor unit in another additional dedicated pig, and FIG. 4d shows a cleaning pig with several vibration units having synchronization mechanisms;

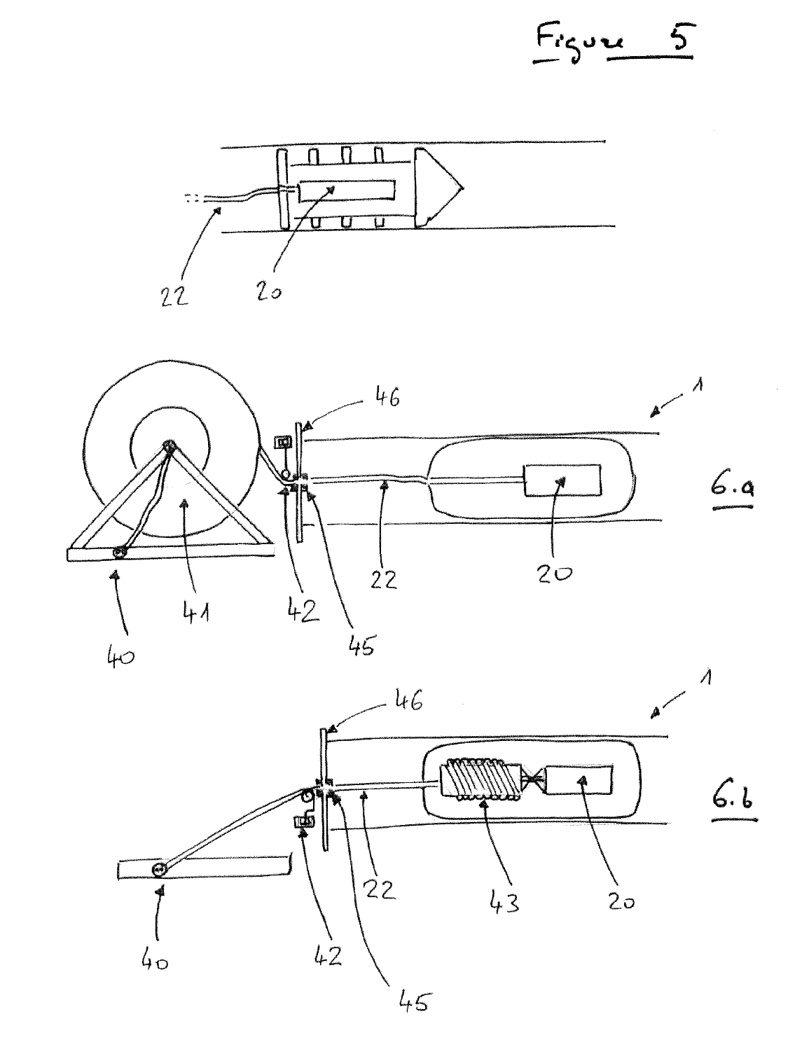

FIG. 5 shows an example of a cleaning pig made of rigid material and with a vibration unit;

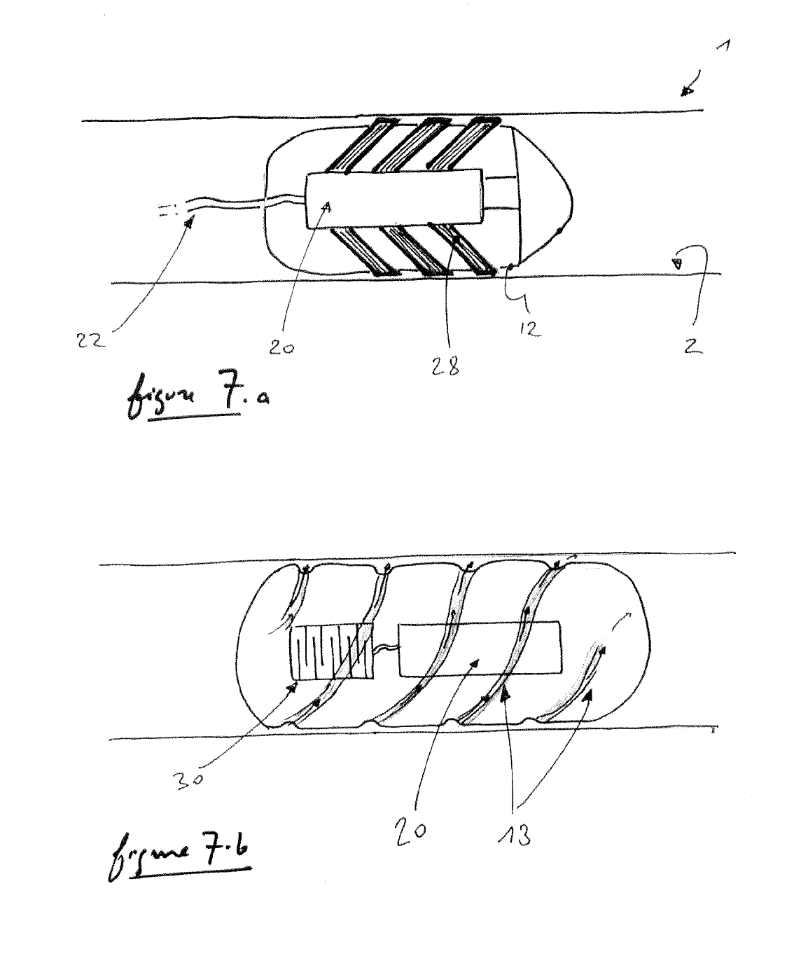

FIG. 6 includes two examples of cable-powered cleaning pigs, where FIG. 6a shows a cleaning pig with a winch external to the pipeline and FIG. 6b shows a cleaning pig with an embarked winch for the power cable;

FIG. 7 illustrates examples of pig surfaces, with FIG. 7a showing a cleaning pig with scraping blades, and FIG. 7b showing a cleaning pig with spiral grooves;

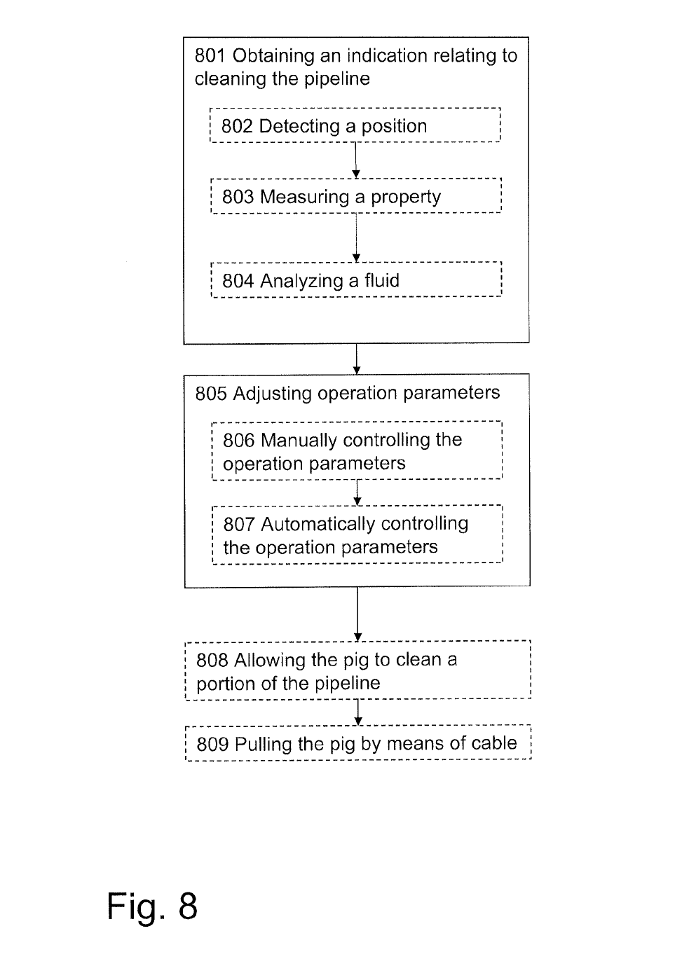

FIG. 8 is a schematic flow chart illustrating a method for adjusting the vibration frequency of the vibration unit in the cleaning pig; and

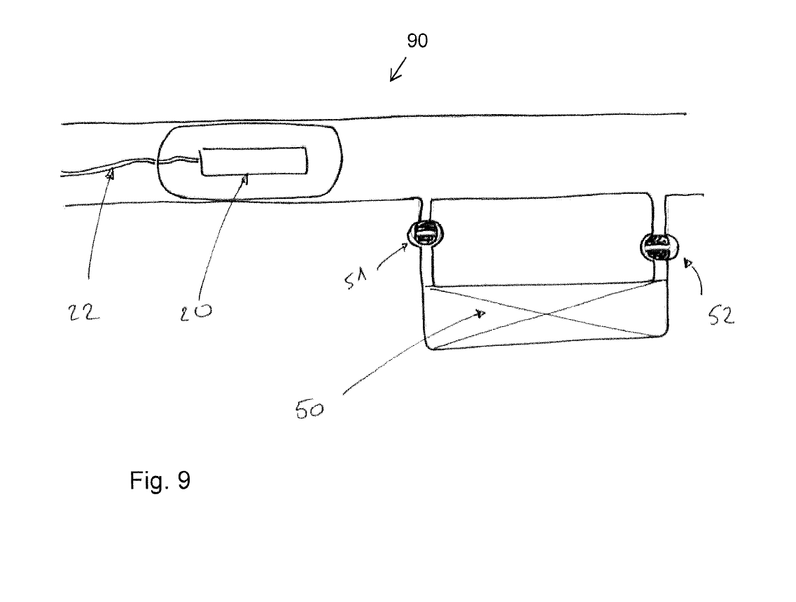

FIG. 9 shows a sampling and analysis unit on the pipeline.

According to an example shown in FIG. 1, there is provided a cleaning pig 10 comprising a body 11 and a vibration unit 20 for generating vibrations which are transmitted to a pipeline 1 through the body of the pig. The body 11 comprises a soft polymer material enclosed by an outer surface, which is in moving contact with the inner surface of the pipeline 1 in order to clean it. Movement of the pig 10 is driven by the fluid within the pipeline, which is hence referred to herein as the motive fluid. The vibrations will improve the scrubbing effect of the pig surface 12 against the inner surface 2 of the pipeline 1 and hence improve the cleaning of the pipe surface by the pig 10. This effect is amplified if the pig outer surface is covered with a rough surface or appendages (protrusions). These may be “sand-paper” type surface elements, scraping blades, various types of appendages, jets, steel plates etc. An example of a cleaning pig with scraping blades 28 is illustrated in FIG. 7a.

Cleaning of a pipeline with the pig 10 may be performed after erection of the piping in order to eliminate bits and pieces such as welding bits, dust etc. This will improve durability of the installed equipment if these pipes are to carry lubrication or cooling fluids to heavy equipment such as pumps, generators etc, installed at the pipe.

The pig may also or alternatively be used for regular cleaning of a transport pipeline, in order to remove biofilm, particles, scaling etc. The preferred embodiments of invention, by allowing more effective cleaning, will reduce downtime for cleaning both in duration and frequency, and will also improve flow management and reduce pumping costs.

In the lower portion of FIG. 1, there is illustrated a cross-sectional view along A-A of the pipeline 1 and the pig 10. In this view, the electric motor 27 is omitted.

The embarked vibration unit 20 may be installed in the pig through various techniques. It may be inserted through an opening, axial or lateral, inside the pig. Or the pig may be produced in several parts, for example two halves, divided longitudinally or laterally, and the vibration unit 20 may be positioned between and within these parts.

The chamber for holding the vibration unit may be moulded, cut or melted in the pig, or may be just absent in the case of a soft pig, the soft pig material deforming resiliently around the vibration unit.

Once the vibration unit has been placed in the pig, the resulting pig assembly may be reinforced with glue, straps, clamps, screws, or any known solution available to the person skilled in the art.

Frequency of vibrations can be in the range of less than 1 to 200 Hz, preferably in a range generating more significant displacements, i.e. 20 to 60 Hz, and in the case of an electrical driven vibration unit preferably the frequency not requiring any frequency conversion, i.e. 50 or 60 Hz.

An important parameter in cleaning efficiency is the amplitude of the oscillatory effect, generally related to the frequency. In one preferred vibration unit considered, the higher the frequency, the lower the amplitude.

Another parameter is the energy released at each vibration cycle. In one preferred vibration unit considered, the higher the frequency, the lower the energy which is released. And the higher the amplitude, the higher the energy released.

However, and depending on the vibration unit apparatus selected, amplitude, energy and frequency are not necessarily dependent parameters, and we will call this non exclusive list of parameters the operation parameters. As the optimal frequency range may be dependent on many parameters such as size and type of vibration unit, characteristics of cleaning enhancing appendices or type of material covering the surface of the pig, it may be an advantage to be able to modify the operation parameters either before launching the cleaning pig, or during operations.

For example, a specific operation parameter range may show best results at welding locations, whereas another range is optimally used between welding points, so as for example to achieve high translation speed while still having good cleaning. Such operation parameters change can be programmed in a predictive manner, for example depending on a location sensing unit or depending on the thick layer of scaling detected in a previous pig running. Such operation parameters can also be controlled automatically thanks to an inner surface quality sensing unit such as an acoustic thickness sensor or a camera reporting to a control unit. The operation parameters can also be controlled by a feedback from the fluid sample and analysis unit, for example requiring extra strong cleaning if the sample shows much dirt. The vibration unit operation parameters may be steered automatically in an un-manned process, a control unit receiving all information and sending the required instructions. Or the process can be manually operated, based on the experience of the operator, enriched if applicable with information from sensors and/or sampling and analysis unit.

The vibrations may enhance the friction and/or cleaning effect by adding an oscillatory translational friction to the general motive fluid-generated translational friction. The vibrations may also be transmitted in a radial direction with respect to a longitudinal axis of the pipeline, or laterally.

Vibrations may be generated by a linear electromechanical converter of the type described in patent U.S. Pat. No. 7,679,227 and US 20090058201 to Resonator. Vibrations may also be generated by any other electric vibrating machine, or any mechanical solution, for example a hydraulically driven one.

Now turning to FIG. 2, there is illustrated how heat may be dissipated from the electric motor 27 of FIG. 1. For simplicity, the electric motor, which is in the same location as in FIG. 1, is not shown in FIG. 2.

When producing vibrations, heat will be generated at the electric motor 27 or converter (vibration unit 20) level, and may need to be dissipated by forced cooling, either to prevent damages to the vibration unit 20 and/or the pig, or to improve efficiency. A preferred forced cooling solution is to allow for one or several channel(s) 23 through the pig, through which the motive fluid circulates and is allowed to cool the heat source by an ad-hoc solution. In the case of the linear electromechanical converter referred to above, a central cooling channel 23 in thermal contact with the piston may be designed as shown in FIG. 2. In such case, and if relevant, an electrical power connection 22 will be connected to the vibration unit 20 on the side.

According to some embodiments, power is supplied by an electric cable 22, which is connected to the pig and is deployed with the pig during cleaning. In such case, if the cable 22 is reinforced such as in the case of wireline, this wireline may be used to pull back the pig after the pig has completed a cleaning sweep of the pipeline propelled by action of the fluid in the pipeline. The cable 22 is, for example, shown in FIGS. 1 and 2. The wireline may also give extra control on the speed of pigging when the motive fluid is pumped in the same direction as the wire line extension, or on the opposite direction especially if the motive fluid pressure is lowered so that an slight extra pulling from the wire line is required to translate the pig. When being wound back, the pig may preferably—depending on the symmetry of its design—be cleaning the inner surface of the pipeline. The pig may also be returned to its initial position thanks to a motive fluid pumped in the opposite direction. In such situation, re-winding will have to be adapted to the translation speed. The cable or wire line may also participate in locating the pig during cleaning, a function possible as for oil and gas logging by adding a cable-length counter to the wireline winding/unwinding winch. This is known to a person skilled in the art, and is for example described in U.S. Pat. No. 5,155,922 to Schlumberger.

Electrical power may as an alternative or a complement be generated by a mini-generator 25 fed by hydraulic energy captured by a rotor in one or several channel(s) 23 traversing the pig, as shown in FIG. 3. The detailed design for the rotor, its position, and the characteristics of the channel(s) are to be defined according to principles known by the man skilled in the art. Such generator is for example used in the UV-irradiating pig described in WO 2009068846 to Halliburton.

In FIG. 4a, there is shown another embodiment, according to which the cleaning pig 10 includes a battery 30 rather than being powered via an electrical cable. In such latter case, the battery 30 may be included in the pig 10, or included in a following pig 10′ connected to the first pig 10 containing the vibration unit, see FIG. 4b, thus improving the pig's capacity to travel through bends, and easing the operation of replacement of a battery. Pigs 10 and 10′ are linked through a mechanical connection 31 and an electrical connection 32, which is preferably fitted within the mechanical connection 31. There may of course be alternatives with several modules, see FIG. 4c, for example an additional pig 10″ including a sensing unit 35, for instance to test thickness of the pipe, locate the pig in the pipeline and/or serve a camera. Pigs 10, 10′ and 10″ are preferably linked through an electrical connection 32, 34 preferably fitted within the mechanical connection 31, 33. A similar modular solution for a pipeline monitoring pig is disclosed in US 2002/0011124.

When several pigs 10 are used, and when cooling of the vibration unit or any other battery or sensor unit is necessary, cooling channel(s) may be necessary through each pig unit.

Modularity is an interesting alternative for increasing or more generally controlling the effect by the vibration units. FIG. 4d illustrates a solution with multiple vibration units 20, here represented with an oscillatory link 26 to keep them for example with a constant phase difference. But the vibration units 20 may also be randomly phased in relation to each other. Multiple vibration units 20 need not be installed axially one after the other. They may also be distributed radially, preferably according to a uniform pattern. For example, three units may be positioned at 120 degrees from each other.

In order to improve propagation of the vibrations, and/or anchoring of the vibration unit in the pig, or dissipating the heat, protrusions 21, 24 can be added to the vibration unit or more generally to the pig. In FIGS. 4 to 6 no protrusion has been represented.

Vibrations may also be generated thanks to the capture of hydraulic energy in one or several channels traversing the pig, and where the motive fluid pushing the pig will activate an oscillating mechanical hydro-mechanical pendulum generating vibrations.

Scrubbing, scouring, brushing, grinding, honing and so on can be improved for this vibrating pig thanks to all sorts of appendices, abrasive elements, jets or elements added to the pig, such as those described in U.S. Pat. No. 4,077,079 listed above. The pig can also be produced with a spiral slit groove 13, as shown in FIG. 7b, so as to induce a rotational motion in addition to the translational motion generated by the fluid, thus improving cleaning. Dirt collected in the process is chased in front of the pig thanks to the extra fluid streams circulating at the groove. Or the pig can combine groove and abrasive coverage, such as the one described in EP 0277010. The scrubbing or scraping solution can be mechanically connected to the embarked vibration unit, as has been illustrated in FIG. 7a, showing scraping blades 28. An improved cleaning effect can be obtained thanks to jets positioned at the head or the tail of the pig, which may be fed by the motive fluid. Cleaning can also be improved by ultrasound emitting cells, directed at the inner surface of the piping. Capture of magnetic particles may be enhanced thanks to additional magnets located at surface or within the pig. As an alternative, non magnetic plates may be magnetised by for instance action of the vibration unit.

A preferred embodiment is a pig made of a soft spongy or foamy material, adapting well to the piping irregularities and bends.

If the pig is soft, the soft part of the pig may be made of one or several polymers, and need not be made of a single material. It can be made of several layers with material of same or different characteristics in order to be robust and have the required mechanical characteristics, and have good cleaning effect. Various reinforcing structures 24 may also be inserted or be drowned in the polymer foam in order to improve the mechanical characteristics.

To improve anchoring in the pig, and transmission of vibrations, the vibration unit may be equipped with various protrusions, such as preferably anchoring “flanges” 21, i.e. any ring welded or bolted to the vibration unit. Anchoring and vibration transmission may be also be provided by means of different specialised parts. Mechanical elements not connected directly to the vibration unit may also be added. Walls, ribs, cells may help reinforce the pig, or influence propagation of the vibrations (for example channelling them radially), or help disseminating the heat produced.

For a foam pig, or a pig comprising any other soft (deformable and/or resilient) polymer material, the vibrations may also enhance friction by generating oscillatory expansion of the pig, thus adding increased radial friction cycles to the general motive fluid-generated translational friction between the outer surface of the pig and the inner surface of the pipeline. The preferred embodiments of FIGS. 1 to 5, 6 and 7 can be made of a flexible polyether MDI (methylene diphenyl diisocyanate) polyurethane foam material. The mechanical properties of the flexible foam are a function of the isocyanate index. The isocyanate index range for this material system is typically 80-110. The properties of the foam material will also vary dependent on how it is formed and the degree to which it is expanded before it sets. This can be varied depending on the mould size and the amount of foam precursor materials that are used. In one example the foam is expanded to a density of 45 g/l and with isocyanate index ranging between 80-110 the properties of the foam are set out below:

Compression hardness at 40% compression [kPa): 1.7-5.3

Tensile strength (kPa): 74-108

Elongation at break (%): 109-96

Compression set at 50% compression (%): 9.1-5.1

Other densities of foam can also be used. In one non-limiting set of examples similar foams were expanded in a generally cylindrical shape with diameter and length as set out below, giving ranges of densities as set out below:

Ø125 mm, length 300 mm: densities in the range 70-115 g/l

Ø170 mm, length 450 mm: densities in the range 81-135 g/l

Ø225 mm, length 450 mm: densities in the range 55-90 g/l

Ø315 mm, length 600 mm: densities in the range 45-70 g/l

Ø470 mm, length 920 mm: densities in the range 45-70 g/l

As a foam or soft polymer will generally be a weak thermal conductor, radiating plates may be designed to extend the thermal exchange surface between the vibrating motor and the foam. These plates may be the ones anchoring the vibration unit in the pig 21, or the ones that are designed to improve vibration energy transmission 24 drawn on FIG. 3, if required. For similar reasons it is advantageous for a pig comprising foam or a soft polymer to also include channels 23 that will provide cooling as the motive fluid in the pipeline passes through the pig.

If the pig is provided with electrical power via a cable or wire line, an unwinding/winding solution is required, and the crossing of the pressure barrier (the wall of the pipeline) needs to be designed so as to avoid leakages.

Winding and unwinding can be performed at the level of a motor-driven and/or spring-loaded winch located outside of the piping, see FIG. 6a, in which cable 22 is wound on a winch 41, and connected to an external electrical power source at 40. A tension reel and a cable-length counter 42 allow smoother operation and cable length measurement. These two functions can be separated also. A leakage-proof packing 45 is installed where the power cable crosses the pressurised piping volume, in our illustration through a dedicated flange 46.

An alternative for shorter distances is to have the cable or wire line wound within the pig at a coil 43, as shown in FIG. 6b.

Both solutions may be including a cable-length measurement device 42, such as for example the one described in the Schlumberger patent U.S. Pat. No. 5,155,922. Note that although the pipeline to clean will typically not be vertical, the power cable 22 feeding the pig will be under tension due to effect of the motive fluid on the pig, thus limiting distance errors due to non linear cable in the pipe.

In both embodiments described above, a fluid-tight crossing will be used for the cable. Such solution may be of the stuffing box, compression gland, or any other type as is known to a person skilled in the art.

Although the preferred embodiments of the invention have been illustrated with reference to FIGS. 1 to 4, 6, 7 and 9 with a pig of soft appearance, and hence preferably comprising a soft material such as a foam or soft polymer as discussed above, it shall be noted that a pig comprising a common hard structure as a body, as represented in FIG. 5, is also considered advantageous, although is outside the scope of the currently appended claims.

FIG. 8 shows a schematic flow chart of an exemplifying a method for adjusting a set of operation parameters relating to a pig 10 for cleaning of the pipeline 1. The pig 10 is shown in various preferred embodiments with reference to FIG. 1-7 above and FIG. 9 described below. The pig 10 may be conveyed in the pipeline 1. The pig 10 may comprise a controlling unit for performing some of the actions indicated below. The pig 10 may further comprise a cable 22 for providing power to the pig 10. Typically, the cable 22 is arranged to provide power to the vibration unit 20, a sensor unit or the like.

The set of operation parameters relating to the pig 10 may comprise one or more of: a vibration frequency for a vibration unit 20 comprised in the pig 10, a vibration amplitude for a vibration unit 20 comprised in the pig 10, a vibration energy level for a vibration unit 20 comprised in the pig 10, and/or a number of cleaning actions to be performed between a start point and an end point of the pipeline 1, wherein the start and end points defines a length of the pipeline for cleaning.

The following actions may be performed. The order of the actions may, according to some embodiments, differ from the order illustrated in FIG. 8 and in the following description.

Action 801

An indication relating to the cleaning of the pipeline 1 is obtained.

Action 802

A position of the pig may be detected. The indication may be based on the position of the pig 10. The position of the pig 10 may measured along the length of the pipeline 1 or as a geographical position coordinate. The indication of properties of the pipeline 1 related to the position may be retrieved from a database.

Action 803

A property of the pipeline may be measured by means of a sensor device comprised in the pig 10. The indication may be based on the measured property. The indication of properties of the pipeline 1 may be retrieved from a database. The database comprises a plurality of posts for mapping the position to the indication.

Action 804

A fluid flowing in the pipeline may be analyzed.

Action 802 and/or action 803 and/or 804 may be performed together or in series.

Action 805

The set of operation parameters is adjusted based on the indication relating to the cleaning of the pipeline 1.

Action 806

The adjustment may be performed by manually controlling the set of operation parameters.

Action 807

The adjustment may be performed by automatically controlling 807 the set of operation parameters. The controlling unit may perform the automatic control of the set of operation parameters. As a further example, the adjustment may be performed semi-manually by controlling the set of parameters upon recommendations from a control unit. Next, an operator of the system confirms a set of operation parameters provided by the control unit.

Action 808

The pig may be allowed to clean a portion of the pipeline 1 when passing, from a first position to a second position, through the portion.

Action 809

The pig 10 may return from the second position to the first position by use of the cable. For example, the pig 10 may return by means of pulling the cable. The pulling by means of the cable may comprise rewinding the cable, thereby moving the pig 10 from the second position to the first position. Or the pig may be returned to its initial position by circulating the motive fluid in the opposite direction, while rewinding the power cable if applicable. Or the pig may be extracted at the other end of the pipeline.

Referring to FIG. 9, there is illustrated a system for cleaning of a pipeline 1, comprising a pig 10, a pipeline 1 with at least one sampling port, such as an inlet 51 and a return connection 52, for receiving a fluid to be passed through the pipeline 1, an analyzing unit, such as the sampling and analysis unit 50, arranged to receive the fluid via the at least one sampling port of the pipeline 1.

The system may further comprise an external control unit (not shown), being located outside the pipeline 1, for controlling a set of operation parameters of the pig 10.

The set of operation parameters relating to the pig 10 may comprise one or more of a vibration frequency for a vibration unit 20 comprised in the pig 10, a vibration amplitude for a vibration unit 20 comprised in the pig 10, a vibration energy level for a vibration unit 20 comprised in the pig 10, and a number of cleanings to be performed between a start point and an end point of the pipeline 1, wherein the start and end points defines a length of the pipeline for cleaning.

The product of cleaning, i.e. particles and organisms produced during cleaning are of interest, as they allow refined diagnostic of the installed equipment of the quality of pipeline installation. Thus, the sampling and analyses unit 50 can be installed on the pipeline via the inlet 51, and optionally the return connection 52.

Patent publications WO 2008/111851, WO 2008/023992, US 2004165185, U.S. Pat. No. 7,082,848, WO 2002/068109, U.S. Pat. No. 5,370,005 and U.S. Pat. No. 5,572,320 all relating to apparatus or methods of sampling and analysis and describe systems and methods that could be used in part or in whole in the sampling and analysis unit 50. For example, the results of the analysis reported to a control unit could be taken into account for defining the vibration unit operation parameters—for instance, very much dirt generating higher energy vibrations. The results from the analysis can also trigger a second cleaning pass of the pig in the pipeline, either through an automatic feedback from the control unit, or through an instruction to the operator.

The sampling and analysis unit 50 enables documentation of the cleaning. A pig cleaning certificate can be delivered by the cleaning contractor to the client. An independent third party certification is also a possibility.

One or several sampling and/or analysis units can be installed. Pressure connections to the pipelines are required, at end flanges, or along the path of the pig. Sampling can be triggered by the passing of the pig. For example, in the case of the spiral groove pig, chasing dirt at the front, sampling can be triggered before the pig passes the sampling connection.

Even though embodiments of the various aspects have been described, many different alterations, modifications and the like thereof will become apparent for those skilled in the art. The described embodiments are therefore not intended to limit the scope of the present disclosure.

1. A pig for cleaning of a pipeline, the pig comprising:
a body for passing through the pipeline, wherein the body comprises a polymer foam material and has an outer surface for cleaning an inner surface of the pipeline,
a vibration unit within the body for generating vibrations and for transmitting the vibrations to the outer surface of the body, wherein the vibration unit is enclosed by the outer surface, wherein the vibrations are transmitted from the vibration unit to the outer surface of the body through the soft polymer foam material of the body, and wherein the soft polymer foam material is arranged to move in oscillation with the vibrations.

2. The pig as claimed in claim 1, wherein the vibration unit comprises an electric motor for driving the vibration unit for generation of the vibrations.

3. (canceled)

4. The pig as claimed in claim 2, wherein the soft material consists of a deformable or resilient material and is selected so that when the pig is held within a pipeline the movement of the vibration unit will be able to readily deform the body of the pig by means of the generated vibrations.

5. The pig as claimed in claim 1 wherein the soft material has a Young's modulus of 300 MPa or less.

6. The pig as claimed in claim 1 wherein the soft material has a strength of 100 MPa or less.

7. (canceled)

8. (canceled)

9. The pig as claimed in claim 1, being a hydraulic pig where the motion of the pig along the pipeline is driven by the fluid within the pipeline.

10. The pig as claimed in claim 1, wherein the vibration unit comprises a mechanical generator adapted to receive a fluid for mechanically generating the vibrations.

11. The pig as claimed in claim 1, comprising a layer enclosing the outer surface of the body, wherein the layer comprises one or more of: brushes for cleaning the inner surface of the pipe, appendages for cleaning the inner surface, outlets for jet of a fluid for cleaning the inner surface, magnetised steel plate for collection of iron particles, and/or an abrasive surface for cleaning the inner surface.

12. The pig as claimed in claim 1, wherein the vibration unit is configured to vibrate the pig in a lateral direction with respect to a direction of travel when the pig is conveyed through the pipeline.

13. The pig as claimed in claim 1, comprising:
at least one protrusion extending, from the vibration unit, in a lateral direction with respect to the body.

14. The pig as claimed in claim 13, wherein at least one of said at least one protrusion is configured to transmit the vibrations to the body and the outer surface thereof.

15. The pig as claimed in claim 13, wherein at least one of said at least one protrusion is configured to anchor the vibration unit to a position within the body.

16. The pig as claimed in claim 13, wherein at least one of said at least one protrusion is configured to dissipate heat from an electric motor of the vibration unit.

17. The pig as claimed in claim 1, wherein the body comprises at least one channel configured to dissipate heat from an electric motor of the vibration unit by means of flow of a fluid through said at least one channel.

18. A method for adjusting a set of operation parameters relating to a pig for cleaning of a pipeline in which the pig is conveyed, wherein the method comprises:
obtaining an indication relating to the cleaning of the pipeline, and
adjusting the set of operation parameters based on the indication relating to the cleaning of the pipeline; and
wherein the pig comprises a body for passing through the pipeline, wherein the body comprises a polymer foam material and has an outer surface for cleaning an inner surface of the pipeline,
a vibration unit within the body for generating vibrations and for transmitting the vibrations to the outer surface of the body, wherein the vibration unit is enclosed by the outer surface, wherein the vibrations are transmitted from the vibration unit to the outer surface of the body through the soft polymer foam material of the body, and wherein the soft polymer foam material is arranged to move in oscillation with the vibrations.

19. The method according to claim 18, wherein the set of operation parameters relating to the pig comprises one or more of:
a vibration frequency for the vibration unit comprised in the pig,
a vibration amplitude for the vibration unit comprised in the pig,
a vibration energy level for the vibration unit comprised in the pig, and
a number of cleanings to be performed between a start point and an end point of the pipeline, wherein the start and end points defines a length of the pipeline for cleaning.

20. The method according to claim 18, wherein the obtaining of the indication relating to the cleaning of the pipeline comprises one or more of:
detecting a position of the pig, wherein the indication is based on the position of the pig,
measuring a property of the pipeline by means of a sensor device comprised in the pig, wherein the indication is based on the measured property, and
analyzing a fluid flowing in the pipeline.

21. The method according to claim 17, wherein the adjustment of the set of operation parameters comprises:
manually controlling the set of operation parameters, or
automatically controlling the set of operation parameters, wherein the pig comprises a control unit for performing the automatic control of the set of operation parameters, and/or
semi-manually controlling the set of parameters upon recommendations from a control unit, wherein an operator of the system confirms a set of operation parameters provided by the control unit.

22. The method according to claim 18, wherein the pig further comprises a cable for providing power to the pig, wherein the method further comprises:
allowing the pig to clean a portion of the pipeline when passing, from a first position to a second position, through the portion of the pipeline, and
returning the pig by use of the cable from the second position to the first position.

23. A system for cleaning of a pipeline, comprising:
a pig comprising a body for passing through the pipeline, wherein the body comprises a polymer foam material and has an outer surface for cleaning an inner surface of the pipeline,
a vibration unit within the body for generating vibrations and for transmitting the vibrations to the outer surface of the body, wherein the vibration unit is enclosed by the outer surface, wherein the vibrations are transmitted from the vibration unit to the outer surface of the body through the soft polymer foam material of the body, and wherein the soft polymer foam material is arranged to move in oscillation with the vibrations,
a pipeline with at least one sampling port for receiving a fluid to be passed through the pipeline,
a sampling and analyzing unit arranged to receive the fluid via the at least one sampling port of the pipeline.

24. The system according to claim 23, further comprising:
an external control unit, being located outside the pipeline, for controlling a set of operation parameters of the pig.

25. The system according to claim 24, wherein the set of operation parameters relating to the pig comprises one or more of:
a vibration frequency for the vibration unit comprised in the pig,
a vibration amplitude for the vibration unit comprised in the pig,
a vibration energy level for the vibration unit comprised in the pig, and
a number of cleanings to be performed between a start point and an end point of the pipeline, wherein the start and end points defines a length of the pipeline for cleaning.
